(19) United States
(12) Patent Application Publication
(10) Pub. No.: US 2015/0042175 A1
(43) Pub. Date: Feb. 12, 2015

(54) Power Supply Device For A Fixed Power Socket

(71) Applicants: Yi Hsiang Chen, New Taipei City (TW); Yi Hsuan Chen, New Taipei City (TW)

(72) Inventors: Yi Hsiang Chen, New Taipei City (TW); Yi Hsuan Chen, New Taipei City (TW)

(21) Appl. No.: 13/960,036

(22) Filed: Aug. 6, 2013

(51) Int. Cl. H02J 3/00

(52) U.S. Cl. CPC H02J 3/00
USPC 307/112

(57) ABSTRACT

A power supply device includes a wireless module, a controlling module, and a connection unit that are connected in series. The power supply device further includes a power supply unit and a power input end. The wireless module includes a wireless transmitting/receiving unit for receiving a remote control signal and a microprocessing unit for converting the remote control signal into an enabling signal. The controlling module includes an enabling unit controlling ON/OFF of power to the connection unit according to the enabling signal. The power input end is connected to a power supply line and supplies electricity to the power supply unit and the enabling unit of the controlling module. The power supply unit is electrically connected to the wireless module, the controlling module, and the connection unit. The connection unit is connected to the monitoring unit and then connected to a power output structure of a power supply apparatus.

### BACKGROUND OF THE INVENTION

The present invention relates to a power supply device and, more particularly, to a power supply device for a fixed power socket for controlling power supply through a wireless transmission technique.

Use of various electric appliances becomes more frequent as a result of development of techniques. Due to reliance on the electric appliances, the plugs of many electric appliances in homes and companies are often left in the power sockets. However, these electric appliances still consume electricity even though they are not in use, and the electricity consumed by the frequently plugged electric appliances is not a low account in the total electricity consumption. Thus, the environmental protecting units keep teaching the users to unplug the electric appliances not in use to avoid unnecessary waste, yet the effect is limited. The main reason is that most users can not effectually unplug the increasing number of electric appliances in their busy lives.

Even though many electric appliances are equipped with switch timers and/or long range wireless controlling switches, the power saving effect is not as good as unplugging. In a different approach, a power switch timer is mounted between the plug of an electric appliance and a power socket to effectively cut off the power supply. However, the design for turning on/cutting off the power supply is complicated and rigid. Specifically, the user has to remove the power switch timer if it is desired to use the electric appliance while the power switch timer is in a mode cutting off the power supply or if it is desired to cut off the power supply while the power switch timer is in another mode supplying power from the power socket to the plug. Furthermore, the power switch timer can be used with only one power socket. A significant increase in the costs is inevitable if control of power supply to many locations is required.

In a company or factory using a lot of electric appliances, controlling the power switches not only saves electricity but involve safety. As an example, the risk of wires catching fire exists because the electric appliances still consume electricity even though they are not turned on. However, precise control of power requires professional workers and increases the costs of labor and time.

### BRIEF SUMMARY OF THE INVENTION

A power supply device for a fixed power socket according to the present invention is adapted to be mounted in an embedding type power supply apparatus having a power supply structure. The power supply device includes a wireless module, a controlling module, a connection unit, a power supply unit, and a power input end. The wireless module, the controlling module, and the connection unit are electrically connected to each other in series. The wireless module includes a wireless transmitting/receiving unit and a microprocessing unit electrically connected to the wireless transmitting/receiving unit. The controlling module includes an enabling unit. The wireless transmitting/receiving unit of the wireless module is adapted to receive a remote control signal. The microprocessing unit converts the remote control signal into an enabling signal. The enabling unit controls ON/OFF of power to the connection unit according to the enabling signal. The power input end allows input of power. The power input end is connected to and supplies electricity to the power supply unit and the connection unit for supplying electricity to the wireless module. The power input end is connected to a power supply line and supplies electricity to the power supply unit and the enabling unit of the controlling module. The power supply unit is electrically connected to and supplies electricity to the wireless module, the controlling module, and the connection unit. The connection unit is connected to the monitoring unit and then electrically connected to the power output structure.

Preferably, the embedding type power supply apparatus includes a bottom adapted to be fixed in the wire groove in a wall after the power input end is electrically connected to the power supply line.

Preferably, a memory unit is electrically connected to the wireless module. Programs are adapted to be written into the memory unit to increase, modify, or upgrade chip program functions of the electric appliance remote control apparatus.

Preferably, the wireless module is a Bluetooth module or WiFi module.

Preferably, the controlling module further includes a monitoring unit and a protecting unit. The monitoring unit of the controlling module monitors power supply conditions of the power supply device and generates an information signal indicative of the power supply conditions. The wireless transmitting/receiving unit receives the information signal from the monitoring unit. The microprocessing unit converts the information signal into a monitoring signal and sends the monitoring signal to a handheld device via the wireless transmitting/receiving unit to provide a user with real time monitoring of the power supply conditions. The protecting unit provides stable supply of electric currents and protects an electric appliance controlled by the handheld device from power surges due to lightning and from overload.

Preferably, the controlling module includes a timing unit electrically connected to the enabling unit.

The present invention will become clearer in light of the following detailed description of illustrative embodiments of this invention described in connection with the drawings.

### DESCRIPTION OF THE DRAWINGS

FIG. 1 is a schematic block diagram of a power supply device according to the present invention.

FIG. 2 is an exploded, perspective view of a power supply apparatus receiving the power supply device of FIG. 1 and mounted in a wall.

FIG. 3 is a partial, cross sectional view of the power supply apparatus of FIG. 2.

FIG. 4 is a schematic block diagram illustrating use of the power supply device according to the present invention with a handheld device.

FIG. 5 is an enlarged view of the handheld device of FIG. 4.

### DETAILED DESCRIPTION OF THE INVENTION

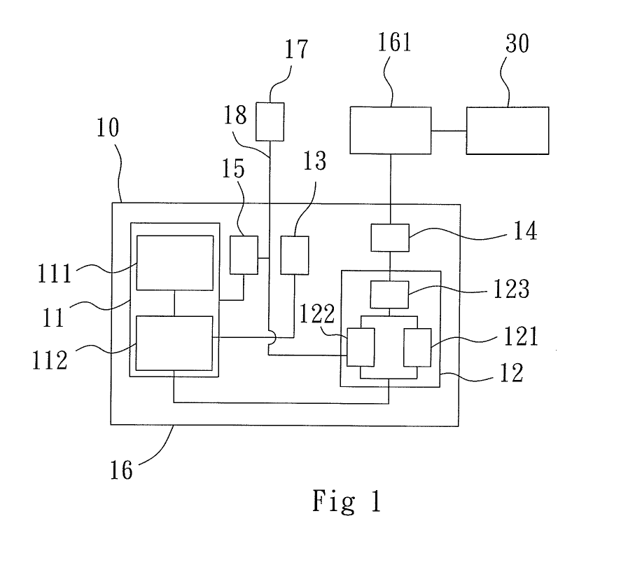

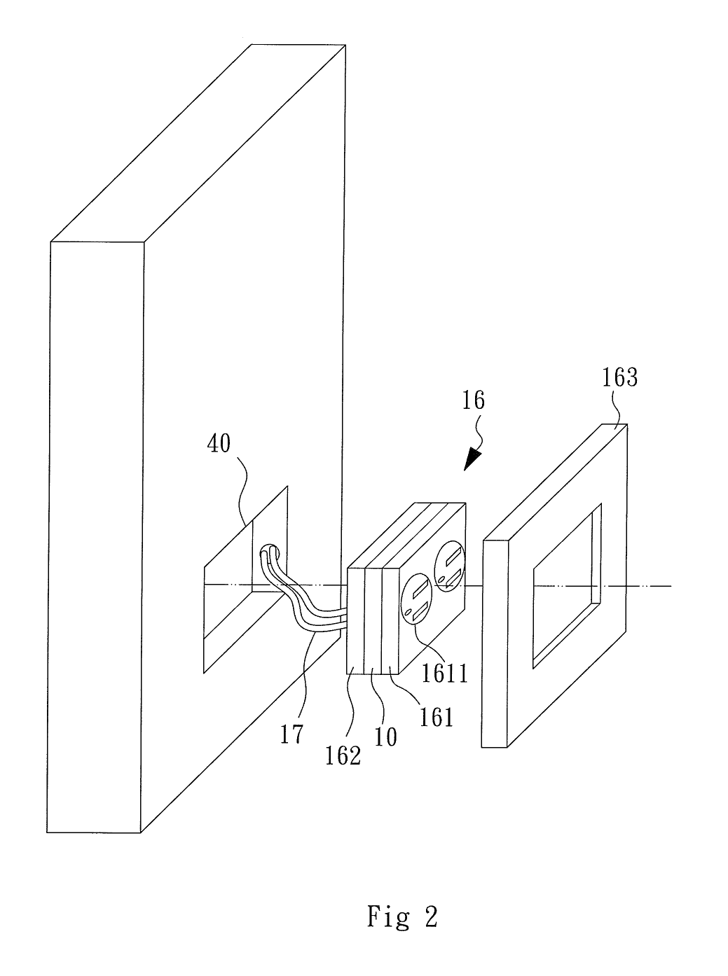

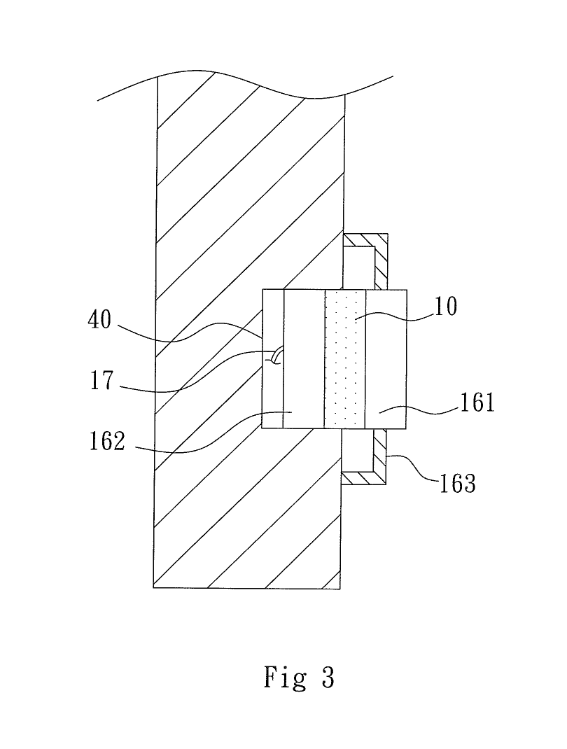

With reference to FIGS. 1-3, a power supply device for a fixed power socket according to the present invention is designated 10 and mounted in an embedding type power supply apparatus 16. The power supply device 10 includes a wireless module 11, a controlling module 12, a memory unit 13, a connection unit 14, a power supply unit 15, and a power input end 18. The wireless module 11, the controlling module 12, and the connection unit 14 are electrically connected to each other in series. The wireless module 11 is electrically connected to the memory unit 13. The wireless module 11 includes a wireless transmitting/receiving unit 111 and a microprocessing unit 112 electrically connected to the wireless transmitting/receiving unit 111. The wireless module 11 can be a Bluetooth module or WiFi (wireless fidelity) module. Programs are adapted to be written into the memory unit 13 to increase, modify, or upgrade chip program functions of the power supply device 10.

The controlling module 12 includes a monitoring unit 121, an enabling unit 122, and a protecting unit 123. The wireless transmitting/receiving unit 111 of the wireless module 11 is adapted to receive a remote control signal. The microprocessing unit 112 converts the remote control signal into an enabling signal. The enabling unit 122 controls ON/OFF of power to the connection unit 14 according to the enabling signal. Furthermore, the monitoring unit 121 of the controlling module 12 monitors power supply conditions of the power supply device 10 and generates an information signal indicative of the power supply conditions. The wireless transmitting/receiving unit 111 receives the information signal from the monitoring unit 121. The microprocessing unit 112 converts the information signal into a monitoring signal and sends the monitoring signal to a handheld device 20 via the wireless transmitting/receiving unit 111 to provide a user with real time monitoring of the power supply conditions. The protecting unit 123 provides stable supply of electric currents and protects an electric appliance from power surges due to lightning and from overload.

The power input end 18 allows input of power. The power input end 18 is connected to and supplies electricity to the power supply unit 15 and the connection unit 14. The power supply unit 15 can be a battery, a transformer, a voltage changing circuit, or a combination thereof. In the form shown, the power supply unit 15 is a transformer or a voltage changing circuit and is connected to a power supply line 17. Alternatively, the power supply unit 15 is directly connected to the power input end 18. The power supply line 17 and the power input end 18 are connected to and supply electricity to the power supply unit 15 and the enabling unit 122 of the controlling module 12. The power supply unit 15 is electrically connected to and supplies electricity to the wireless module 11, the controlling module 12, and the connection unit 14. The controlling module 12 can further include a timing unit electrically connected to the enabling unit 122. The user can set the time for turning on or turning off the power source through the handheld device 20.

The embedding type power supply apparatus 16 is a power socket or power switch device mounted in a wall of a building. The power socket can be engaged with a plug of an electric appliance 30. The power switch device provides ON/OFF control of a lamp. In this embodiment, the wireless module 11, the controlling module 12, the connection unit 14, and the power supply unit 15 are mounted in the embedding type power supply apparatus 16. The embedding type power supply apparatus 16 is fixed in a wire groove 40 in a wall of a building and covered by a lid 163. In the form shown, a power output structure 161 is provided on a front end of the embedding type power supply apparatus 16 and includes sockets 1611 for electrical connection with a plug. However, the power output structure can be a switch for turning on or cutting off power output. The other end of the embedding type power supply apparatus 16 includes a bottom 162 that is fixed in the wire groove 40 in the wall after the power input end 18 is electrically connected to the power supply line 17. The power input end 18 extends out of the embedding type power supply apparatus 16 and is connected to the power supply line 17. The connection unit 14 is connected to the monitoring unit 121 and then electrically connected to an internal electrical connection portion in the power output structure 161.

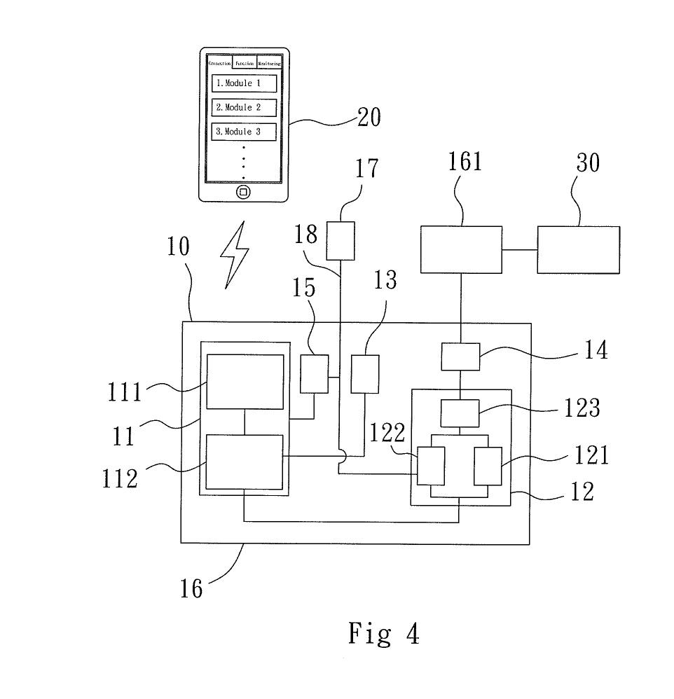

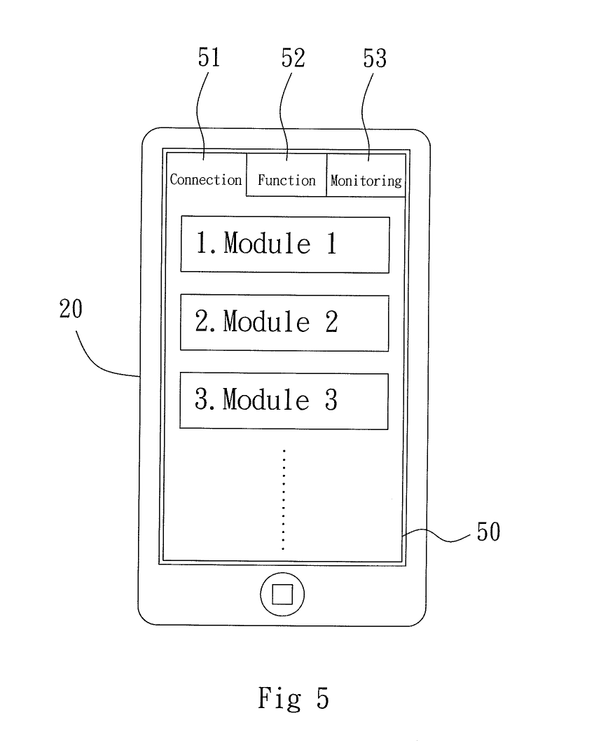

With reference to FIGS. 4 and 5, in use, the plug of an electrical appliance 30 is connected to the power output structure 161, such that the power supply device 10 is electrically connected to the electric appliance 30 to be controlled. Then, monitoring programs corresponding to the power supply device 10 are downloaded by and installed in the handheld device 20. The monitoring programs are presented on a screen of the handheld device 20 and provide an operation interface 50. The operation interface 50 includes a connection setting interface 51, a function switching interface 52, and a monitoring interface 53. The connection setting interface 51 searches and connects with the power supply device 10. A code can be set during the connection to prevent unauthorized access to the power supply device 10. The connection setting interface 51 includes a module switching function to allow use of a plurality of power supply devices 10. The module switching function allows the operation interface 50 to detect each power supply device 10 and to define each power supply device 10 and its connection as a specified electric appliance module. After selecting or adding the specified electric appliance modules, the electric appliances connected to the specified electric appliance modules can be controlled through operation of the function switching interface 52. The function switching interface 52 provides functions of controlling ON/OFF of power, controlling an electricity transmission power, and timing. In a case that the electric appliance is an electric fan, the function switching interface 52 can control ON and OFF of the electric fan and can set the time for automatically turning the electric fan on or off. In another case that the electric appliance is a lamp, the function switching interface 52 can control ON and OFF and brightness of the lamp and can set the time for automatically turning the lamp on or off. The monitoring interface 53 monitors and checks the monitoring signal from the monitoring unit 121 to find out whether abnormal conditions occur in the electric appliance 30, such as overload or insufficient power. If abnormal conditions occur, the monitoring interface 53 generates an alarm, and the user can fix the problems to avoid damage. The handheld device 20 can be a cell phone, a computing device with wireless transmission functions, or a remote controller.

Next, the user sends the remote control signal to the wireless module 11 through the operation interface 50 of the handheld device 20 to control or monitor the specified electric appliance module. Remote control of the electric appliance 30 can be achieved without troublesome operations of turning the power source on or off and of repeated unplugging and replugging. Furthermore, the user does not have to use the remote controller of the electric appliance 30. The user can use a single handheld device 20 to simultaneously or respectively proceed with identical or different control of a plurality of electric appliances 30, allowing rapid, convenient control and selection of a plurality of specified electric modules and the electric appliances 30 connected to the specified electric modules.

In view of the foregoing, the user can directly use the handheld device 20 to download the monitoring programs and can control as many electric appliances 30 as possible, obtaining multiple module control and achieving easy, convenient control at low costs while saving energy.

Although specific embodiments have been illustrated and described, numerous modifications and variations are still possible without departing from the scope of the invention. The scope of the invention is limited by the accompanying claims.

1. A power supply device for a fixed power socket, with the power supply device adapted to be mounted in an embedding type power supply apparatus, with the power supply device comprising a wireless module, a controlling module, a connection unit, a power supply unit, and a power input end,
with the embedding type power supply apparatus including a power supply structure,
with the wireless module, the controlling module, and the connection unit electrically connected to each other in series, with the wireless module including a wireless transmitting/receiving unit and a microprocessing unit electrically connected to the wireless transmitting/receiving unit,
with the controlling module including an enabling unit, with the wireless transmitting/receiving unit of the wireless module adapted to receive a remote control signal, with the microprocessing unit converting the remote control signal into an enabling signal, with the enabling unit controlling ON/OFF of power to the connection unit according to the enabling signal,
with the power input end allowing input of power, with the power input end connected to and supplying electricity to the power supply unit and the connection unit for supplying electricity to the wireless module, with the power input end connected to a power supply line and supplying electricity to the power supply unit and the enabling unit of the controlling module, with the power supply unit electrically connected to and supplying electricity to the wireless module, the controlling module, and the connection unit, and
with the connection unit connected to the monitoring unit and then electrically connected to the power output structure.

2. The power supply device as claimed in claim 1, with the embedding type power supply apparatus including a bottom, with the bottom of the embedding type power supply apparatus adapted to be fixed in the wire groove in a wall after the power input end is electrically connected to the power supply line.

3. The power supply device as claimed in claim 1, further comprising: a memory unit electrically connected to the wireless module, with programs adapted to be written into the memory unit to increase, modify, or upgrade chip program functions of the electric appliance remote control apparatus.

4. The power supply device as claimed in claim 1, with the wireless module being a Bluetooth module or wireless fidelity module.

5. The power supply device as claimed in claim 1, with the controlling module further including a monitoring unit and a protecting unit, with the monitoring unit of the controlling module monitoring power supply conditions of the power supply device and generating an information signal indicative of the power supply conditions, with the wireless transmitting/receiving unit receiving the information signal from the monitoring unit, with the microprocessing unit converting the information signal into a monitoring signal and sending the monitoring signal to a handheld device via the wireless transmitting/receiving unit to provide a user with real time monitoring of the power supply conditions, with the protecting unit providing stable supply of electric currents and protecting an electric appliance controlled by the handheld device from power surges due to lightning and from overload.

6. The power supply device as claimed in claim 1, with the controlling module including a timing unit electrically connected to the enabling unit.
